(19) United States
(12) Patent Application Publication
(10) Pub. No.: US 2024/0340822 A1
(43) Pub. Date: Oct. 10, 2024

(54) SYNCHRONIZATION RASTER BASED ON TRANSMISSION BANDWIDTH

(71) Applicant: QUALCOMM Incorporated, San Diego, CA (US)

(72) Inventors: Toni Harri Henrikki LAEHTEENSUO, Helsinki (FI); Le LIU, San Jose, CA (US); Peter GAAL, San Diego, CA (US); Alberto RICO ALVARINO, San Diego, CA (US); Yongle WU, San Diego, CA (US); Hari SANKAR, San Diego, CA (US); Jae Ho RYU, San Diego, CA (US); Timo Ville VINTOLA, San Diego, CA (US)

(21) Appl. No.: 18/538,553

(22) Filed: Dec. 13, 2023

Related U.S. Application Data
(60) Provisional application No. 63/494,915, filed on Apr. 7, 2023.

(51) Int. Cl. H04W 56/00; H04L 5/00; H04W 8/00; H04W 76/10

(52) U.S. Cl. CPC H04W 56/0015; H04L 5/0092; H04W 8/005; H04W 76/10

(57) ABSTRACT

Various aspects of the present disclosure generally relate to wireless communication. In some aspects, a user equipment (UE) may perform, in accordance with a synchronization raster, a cell search in a channel having a transmission bandwidth that is less than or equal to 5 MHz, wherein the synchronization raster is based at least in part on the transmission bandwidth. The UE may detect, based at least in part on the cell search, a synchronization signal block (SSB). Numerous other aspects are described.

### CROSS-REFERENCE TO RELATED APPLICATION

This patent application claims priority to U.S. Provisional Patent Application No. 63/494,915, filed on Apr. 7, 2023, entitled “SYNCHRONIZATION RASTER BASED ON TRANSMISSION BANDWIDTH,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for a synchronization raster that is based on a transmission bandwidth.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to perform, in accordance with a synchronization raster, a cell search in a channel having a transmission bandwidth that is less than or equal to 5 MHz, wherein the synchronization raster is based at least in part on the transmission bandwidth. The one or more processors may be configured to detect, based at least in part on the cell search, a synchronization signal block (SSB).

Some aspects described herein relate to a network node for wireless communication. The network node may include a memory and one or more processors coupled to the memory. The one or more processors may be configured to output an SSB in accordance with a synchronization raster for a channel having a transmission bandwidth that is less than or equal to 5 MHz, wherein the synchronization raster is based at least in part on the transmission bandwidth. The one or more processors may be configured to establish a connection with a UE based at least in part on the SSB.

Some aspects described herein relate to a method of wireless communication performed by a UE. The method may include performing, in accordance with a synchronization raster, a cell search in a channel having a transmission bandwidth that is less than or equal to 5 MHz, wherein the synchronization raster is based at least in part on the transmission bandwidth. The method may include detecting, based at least in part on the cell search, an SSB.

Some aspects described herein relate to a method of wireless communication performed by a network node. The method may include outputting an SSB in accordance with a synchronization raster for a channel having a transmission bandwidth that is less than or equal to 5 MHz, wherein the synchronization raster is based at least in part on the transmission bandwidth. The method may include establishing a connection with a UE based at least in part on the SSB.

Some aspects described herein relate to a non-transitory computer-readable medium that stores a set of instructions for wireless communication by a UE. The set of instructions, when executed by one or more processors of the UE, may cause the UE to perform, in accordance with a synchronization raster, a cell search in a channel having a transmission bandwidth that is less than or equal to 5 MHz, wherein the synchronization raster is based at least in part on the transmission bandwidth. The set of instructions, when executed by one or more processors of the UE, may cause the UE to detect, based at least in part on the cell search, an SSB.

Some aspects described herein relate to a non-transitory computer-readable medium that stores a set of instructions for wireless communication by a network node. The set of instructions, when executed by one or more processors of the network node, may cause the network node to output an SSB in accordance with a synchronization raster for a channel having a transmission bandwidth that is less than or equal to 5 MHz, wherein the synchronization raster is based at least in part on the transmission bandwidth. The set of instructions, when executed by one or more processors of the network node, may cause the network node to establish a connection with a UE based at least in part on the SSB.

Some aspects described herein relate to an apparatus for wireless communication. The apparatus may include means for performing, in accordance with a synchronization raster, a cell search in a channel having a transmission bandwidth that is less than or equal to 5 MHz, wherein the synchronization raster is based at least in part on the transmission bandwidth. The apparatus may include means for detecting, based at least in part on the cell search, an SSB.

Some aspects described herein relate to an apparatus for wireless communication. The apparatus may include means for outputting an SSB in accordance with a synchronization raster for a channel having a transmission bandwidth that is less than or equal to 5 MHz, wherein the synchronization raster is based at least in part on the transmission bandwidth. The apparatus may include means for establishing a connection with a UE based at least in part on the SSB.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating tables associated with a synchronization raster, in accordance with the present disclosure.

FIG. 5 is a diagram illustrating a table associated with synchronization raster entries for respective operating bands, in accordance with the present disclosure.

FIG. 6 is a diagram illustrating tables associated with a channel raster, in accordance with the present disclosure.

FIG. 7 is a diagram illustrating an example associated with a synchronization raster that is based on a transmission bandwidth, in accordance with the present disclosure.

FIG. 8 is a diagram illustrating an example associated with a transmission bandwidth that is less than or equal to 3 MHz, in accordance with the present disclosure.

FIG. 9 is a diagram illustrating an example associated a transmission bandwidth that is less than or equal to 3 MHz and a table containing associated parameters, in accordance with the present disclosure.

FIG. 10 is a diagram illustrating an example associated with a transmission bandwidth that is equal to 5 MHz and tables containing associated parameters, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Legacy synchronization raster design is too sparse to enable synchronization signal block (SSB) detection in channels having narrow transmission bandwidths (e.g., 3 MHz channels, 5 MHz channels with less than 5 MHz of transmission bandwidth, or the like) for any location within the existing channel raster. Furthermore, the 1200 kHz frequency window employed by the legacy design may cause an SSB (e.g., an SSB having a bandwidth of 20 resource blocks (RBs)) to at least partially fall outside of a narrow transmission bandwidth.

Various aspects relate generally to wireless communication and more particularly to a synchronization raster. Some aspects more specifically relate to a synchronization raster that is based on a transmission bandwidth. For example, the transmission bandwidth may be less than or equal to 5 MHz. In some aspects, a user equipment (UE) may perform, in accordance with a synchronization raster, a cell search in a channel having a transmission bandwidth that is less than or equal to 5 MHz. The synchronization raster may be based at least in part on the transmission bandwidth. A network node (e.g., a gNB) may output, and the UE may receive, the SSB in accordance with the synchronization raster for the channel. The UE may detect the SSB based at least in part on the cell search, and the network node and the UE may establish a connection (e.g., a network connection) with each other based at least in part on the SSB.

Particular aspects of the subject matter described in this disclosure can be implemented to realize one or more of the following potential advantages. Basing the synchronization raster at least in part on the transmission bandwidth may help to ensure that the UE 120 successfully detects an SSB transmitted within a transmission bandwidth that is less than or equal to 5 MHz and that a connection between the network node 110 and the UE 120 can be successfully established.

At least three aspects may be used when the transmission bandwidth is less than or equal to 3 MHz. In a first aspect, a bandwidth of the SSB may be equal to the transmission bandwidth, and a step size of the synchronization raster may be equal to a step size of a channel raster of an operating band, or a frequency range within the operating band, in which the cell search is performed. When the step size of the synchronization raster is equal to the step size of the channel raster, the entirety of the SSB may be transmitted within the transmission bandwidth and, thus, the UE may successfully detect the SSB. In some examples, one or more of the bandwidth of the SSB or the transmission bandwidth of the channel may change (e.g., may not be constant), and the step size of the synchronization raster may be fixed. The fixed step size may improve simplicity for, and reduce burden on, the UE. The fixed step size may also prevent confusion between synchronization rasters.

In a second aspect, a bandwidth of the SSB is less than the transmission bandwidth, and a step size of the synchronization raster may be greater than a step size of a channel raster of an operating band, or a frequency range within the operating band, in which the cell search is performed. The step size of the synchronization raster may or may not be uniform (e.g., for three-point clusters with wide spacing). When the step size of the synchronization raster is greater than the step size of the channel raster, the synchronization raster may be optimized. For example, an individual synchronization raster point may be used for one or more channel raster positions, thereby reducing a quantity of synchronization raster points that are used for the operating band.

In the third aspect, the UE 120 may perform the cell search at a first set of synchronization raster points of the synchronization raster, not detect the SSB in the first set of synchronization raster points, perform the cell search at a second set of synchronization raster points of the synchronization raster, and detect the SSB in the second set of synchronization raster points. When the first set of synchronization raster points is a subset of the second set of synchronization raster points, the third aspect may co-exist with the first aspect optimally. For example, a 100 kHz raster may be used for a 12 RB transmission bandwidth, and a sparser raster may be used for a 15 RB transmission bandwidth. For example, there may be two sets of points, Set 1 and Set 2, where Set 1 is associated with the sparser raster. Set 1 may be sufficient when the transmission bandwidth is 15 RBs (which may be wider than the SSB). However, when the transmission bandwidth is 12 RBs (which may be equal to the SSB), points from Set 2 may be used. The points of Set 1 may be included in Set 2, and as a result, the total quantity of individual raster frequencies may be equal to a quantity of the points of Set 2 (e.g., rather than a sum of a quantity of the points of Set 1 and a quantity of the points of Set 2). When the transmission bandwidth is 12 RBs, the UE may detect the SSB in Set 1 or Set 2. When the transmission bandwidth is 15 RBs, the SSB may be present within Set 1. The UE may begin the search within Set 1, which may apply to both the 12 RB transmission bandwidth and the 15 RB transmission bandwidth. The UE may or may not detect the SSB in Set 1. If the UE detects the SSB in Set 1, then the UE may refrain from searching in Set 2. If the UE does not detect the SSB in Set 1, then the UE may continue the search in Set 2. When only the 15 RB case is used (e.g., in a later phase), the search may be optimized by starting in Set 1 because the SSB may be present within the Set 1 points (e.g., the SSB may be present only within the Set 1 points).

In some aspects, when the transmission bandwidth is less than or equal to 5 MHz, a bandwidth of the SSB may be equal to the transmission bandwidth, and a step size of the synchronization raster may be equal to a step size of a channel raster of an operating band, or a frequency range within the operating band, in which the cell search is performed. When the step size of the synchronization raster is equal to the step size of the channel raster, the entirety of the SSB may be transmitted within the transmission bandwidth and, thus, the UE may successfully detect the SSB.

In some examples, when the transmission bandwidth is less than or equal to 5 MHz, the UE may perform the cell search at a set of synchronization raster points of the synchronization raster, and a subset of the set of synchronization raster points may include synchronization raster points of a global frequency raster or a raster specified for an operating band. When a subset of the set of synchronization raster points includes synchronization raster points of a global frequency raster or a raster specified for an operating band, specific sections of the global frequency raster (or the raster specified for an operating band) may be extended to cover the operating band with additional synchronization raster points.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and aspect constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

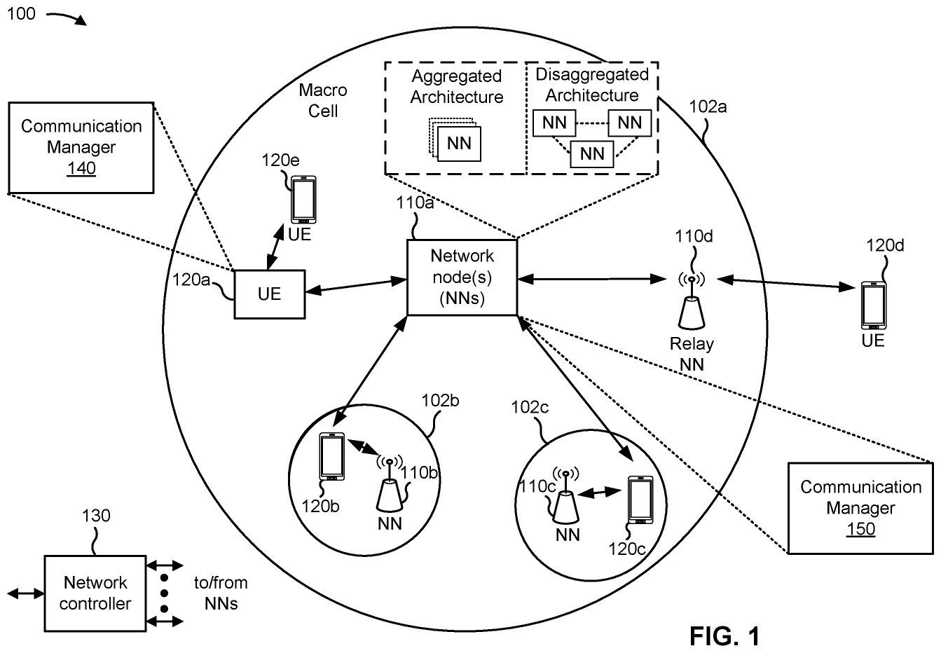

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range (FR) designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may perform, in accordance with a synchronization raster, a cell search in a channel having a transmission bandwidth that is less than or equal to 5 MHz, wherein the synchronization raster is based at least in part on the transmission bandwidth; and detect, based at least in part on the cell search, an SSB. Additionally, or alternatively, the communication manager 140 may perform one or more other operations described herein.

In some aspects, the network node 110 may include a communication manager 150. As described in more detail elsewhere herein, the communication manager 150 may output an SSB in accordance with a synchronization raster for a channel having a transmission bandwidth that is less than or equal to 5 MHz, wherein the synchronization raster is based at least in part on the transmission bandwidth; and establish a connection with the UE 120 based at least in part on the SSB. Additionally, or alternatively, the communication manager 150 may perform one or more other operations described herein.

As indicated above, FIG. 1 is provided as an example. Other examples may differ from what is described with regard to FIG. 1.

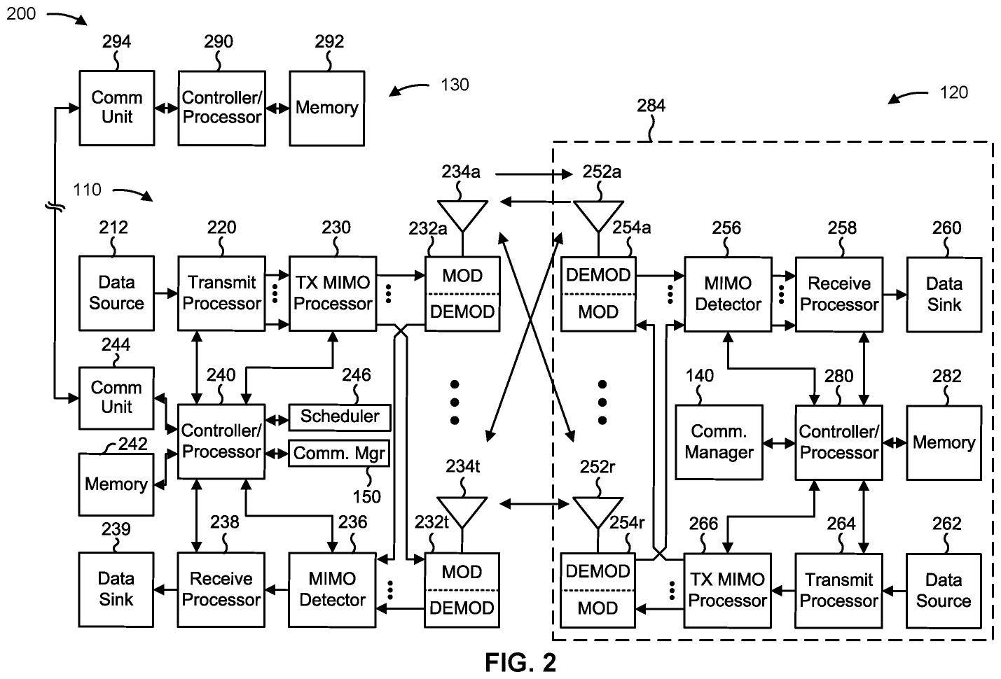

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

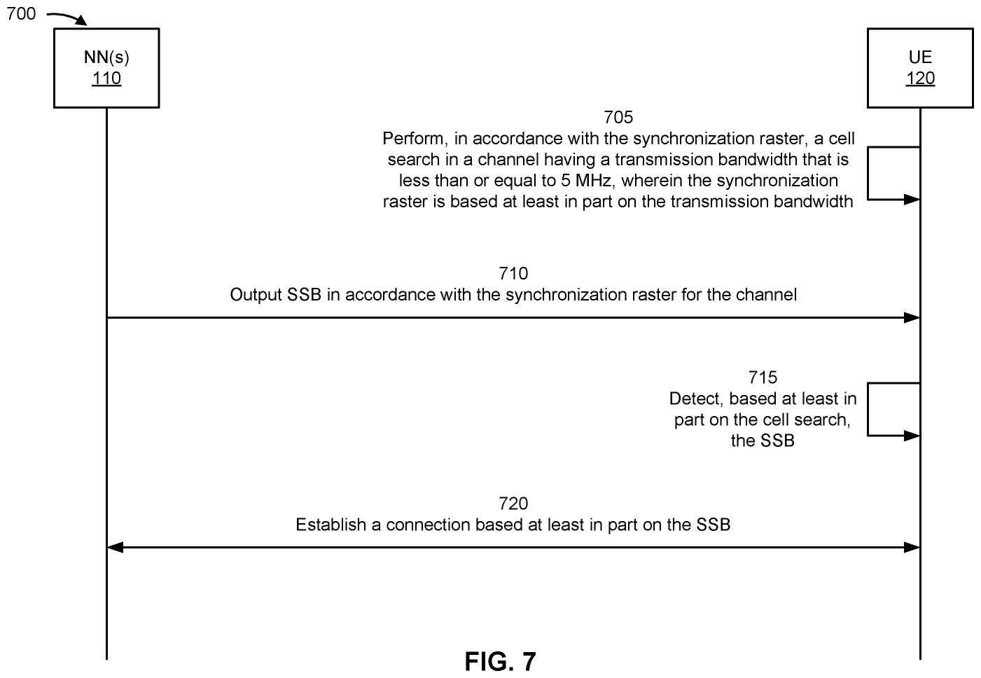

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-14).

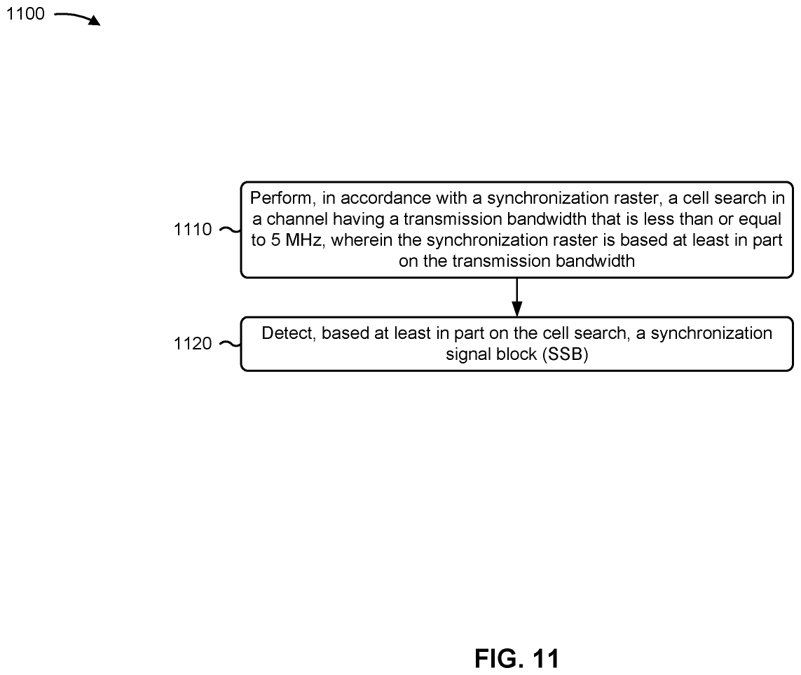

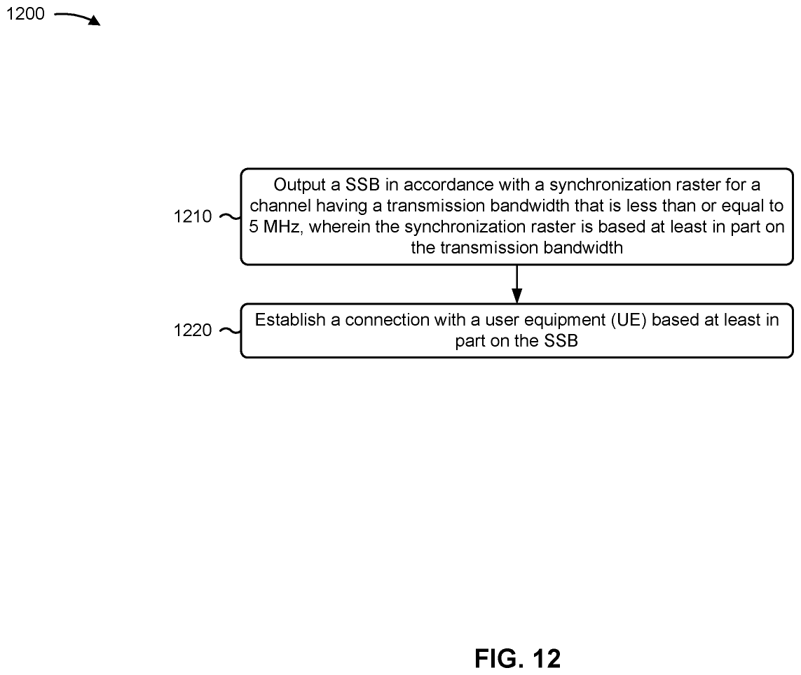

The controller/processor 240 of the network node 110, the controller/processor 280 of the UE 120, and/or any other component(s) of FIG. 2 may perform one or more techniques associated with a synchronization raster that is based on a transmission bandwidth, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE 120 includes means for performing, in accordance with a synchronization raster, a cell search in a channel having a transmission bandwidth that is less than or equal to 5 MHz, wherein the synchronization raster is based at least in part on the transmission bandwidth; and/or means for detecting, based at least in part on the cell search, an SSB. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for outputting an SSB in accordance with a synchronization raster for a channel having a transmission bandwidth that is less than or equal to 5 MHz, wherein the synchronization raster is based at least in part on the transmission bandwidth; and/or means for establishing a connection with the UE 120 based at least in part on the SSB. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

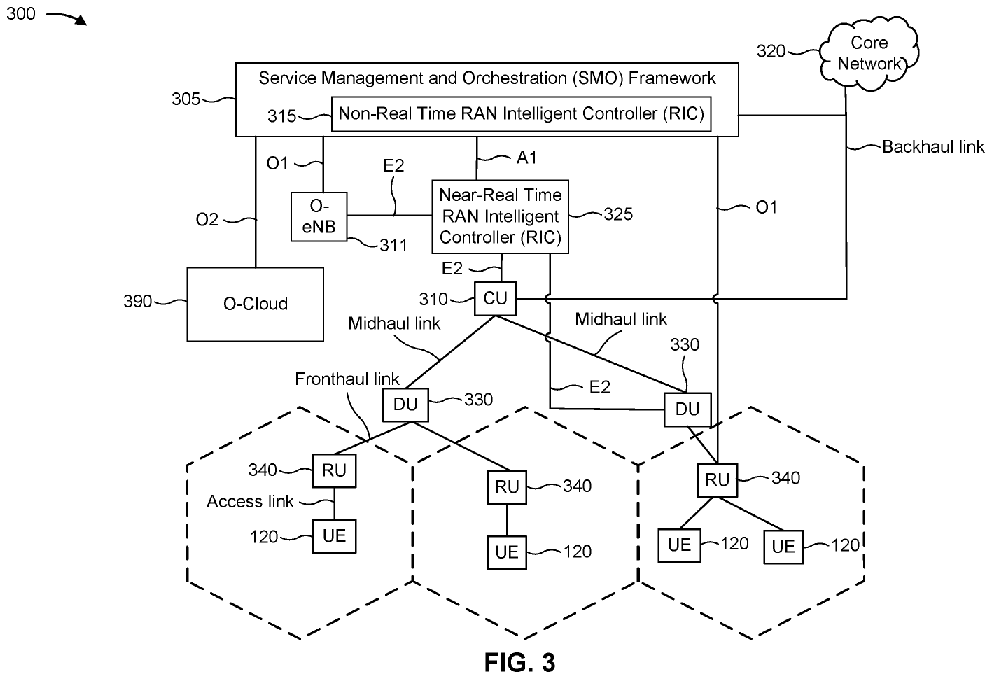

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

In a wireless network, a UE 120 may scan one or more frequencies for SSBs transmitted by the network node 110. An SSB may be used by the UE 120 for system acquisition. An SSB may include a primary synchronization signal (PSS), a secondary synchronization signal (SSS), a physical broadcast channel (PBCH) communication, and/or the like. In some aspects, the PBCH communication may include remaining minimum system information (RMSI), such as an RMSI control resource set (CORESET) configuration and/or the like, which may be used by the UE 120 to determine a random access channel (RACH) configuration for performing a RACH procedure for initial access to the network node 110.

Synchronization signals (e.g., PSSs and/or SSSs) may be transmitted at particular frequency locations that are defined by a synchronization raster. A synchronization raster may indicate the frequency positions of the SSB when explicit signalling of the SSB position is not present. For example, a synchronization raster may refer to an index of frequency locations. For example, in a band associated with a frequency f, possible frequency locations for sending synchronization signals may include f+Nd, where d is the value of the synchronization raster and N is an integer. Each frequency location may be used, for example, as a synchronization raster hypothesis. A synchronization raster hypothesis is a candidate (e.g., potential) frequency index associated with a synchronization raster that may be associated with a synchronization signal.

The NR physical layer may be modified to operate in spectrum allocations from approximately 3 MHz up to 5 MHz. Transmissions may be restricted to a subcarrier spacing of 15 kHz and the use of a normal cyclic prefix. For the SSB, PSS/SSS specifications may be re-used without puncturing, and the PBCH may be based on existing designs. For functional support, changes may be made to the physical downlink control channel (PDCCH), the channel state information reference signal (CSI-RS), the tracking reference signal (TRS), the physical uplink control channel (PUCCH), and/or the physical random access channel (PRACH).

The NR physical layer may be modified to operate in spectrum allocations from approximately 3 MHz up to 5 MHz including in operating bands n26, n28, n85, n100, and/or n106. System parameters (including channel and synchronization rasters) may be specified for the associated dedicated spectrum. For minimal impact on RF requirements, 5 MHz channel bandwidth may be re-used for at least the future railway mobile communication system (FRMCS) use case (e.g., when NR and global system for mobile communication—railway (GSM-R) are co-located with the same operator). RF requirements may be specified for a 3 MHz channel bandwidth in operating bands n26, n28, n85, n100, and/or n106. Radio resource management (RRM) requirements may be specified to support operation in spectrum allocations from approximately 3 MHz up to 5 MHz.

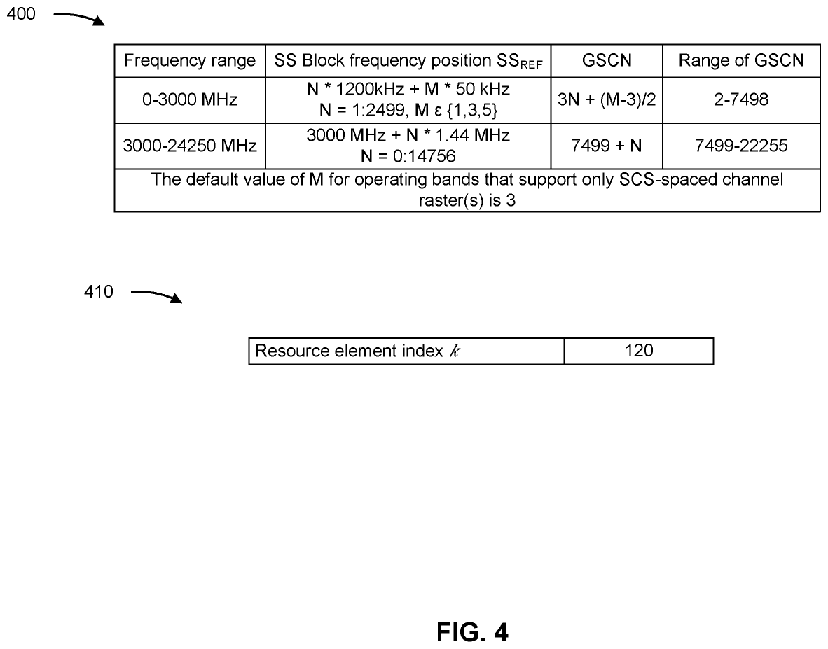

FIG. 4 is a diagram illustrating tables 400 and 410 associated with a synchronization raster, in accordance with the present disclosure. Table 400 relates to a synchronization raster and associated numbering. For example, table 400 indicates global synchronization channel number (GSCN) parameters for a global frequency raster. The global synchronization raster may be defined for multiple (e.g., all) frequencies, and the frequency position of the SSB may be defined as SS_{REF}. As shown in table 400, various parameters may define the SS_{REF} and GSCN for the multiple frequency ranges. The synchronization raster and the subcarrier spacing of the SSB may be defined separately for each band.

As shown, some frequency ranges (e.g., 0 to 3000 MHz), an SSB may be transmitted at one or more frequency positions within a frequency window (e.g., three potential frequency positions with 100 kHz spacing within a frequency window of 1200 kHz, which may be indicated as N*1200+M*50 kHz, where N=1:2499 and M=1, 3, 5). This frequency window may be referred to as a synchronization raster cluster, and may indicate multiple possible frequency positions for SSBs (e.g., multiple SS_{REF}s). Each SS_{REF} may have a corresponding GSCN, which may be used for signaling a SS_{REF} using less overhead.

Table 410 relates to a mapping between the synchronization raster and a corresponding resource element of the SSB. Table 410 indicates synchronization-raster-to-SSB-resource-element mapping. For example, the resource element corresponding to the SS_{REF} may be defined. k may be the subcarrier number of the SSB.

As indicated above, FIG. 4 is provided as an example. Other examples may differ from what is described with respect to FIG. 4.

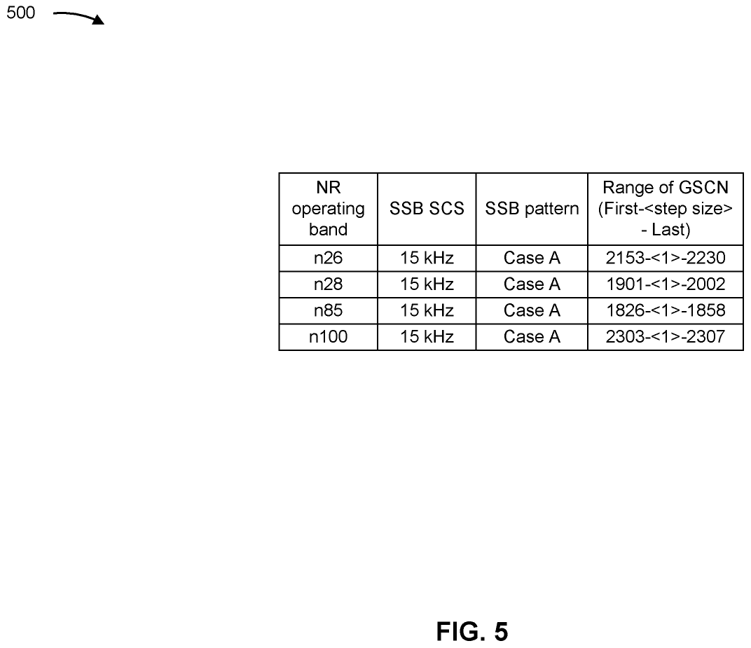

FIG. 5 is a diagram illustrating table 500 associated with synchronization raster entries for respective operating bands, in accordance with the present disclosure. Table 500 indicates a range of GSCN that corresponds to specified operating bands. The <Step size> may be the distance between applicable GSCN entries. Thus, the synchronization raster point (e.g., the frequency around which the SSB is centered) for each operating band may be specified as a subset of the global synchronization raster. The synchronization raster entries may apply to channel bandwidths (e.g., transmission bandwidths) equal to 5 MHz.

As indicated above, FIG. 5 is provided as an example. Other examples may differ from what is described with respect to FIG. 5.

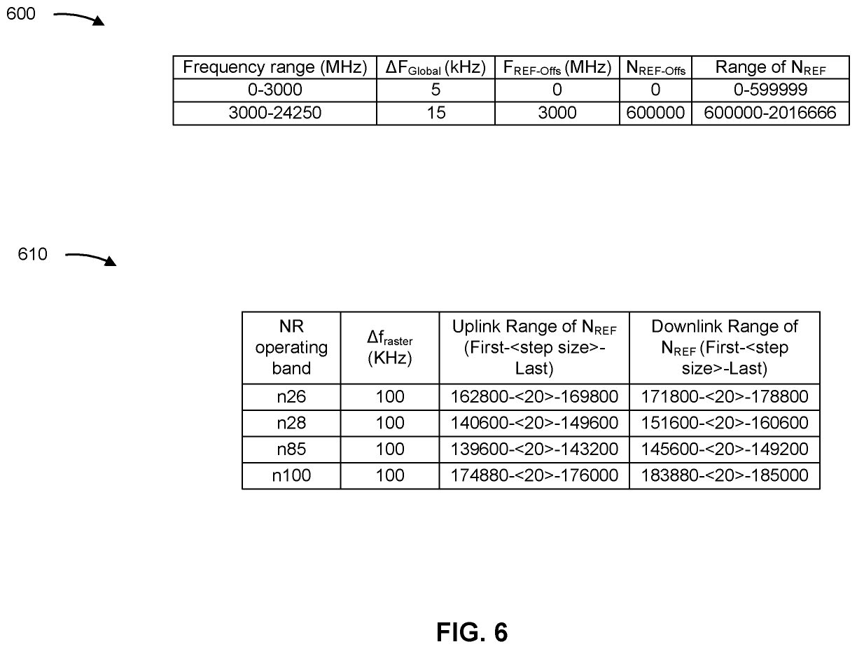

FIG. 6 is a diagram illustrating tables 600 and 610 associated with a channel raster, in accordance with the present disclosure. Table 600 relates to the NR absolute RF channel number (NR-ARFCN) and channel raster (e.g., a global frequency channel raster). Table 600 indicates NR-ARFCN parameters for the global channel raster. The global channel raster may define a set of RF reference frequencies F_{REF}. The F_{REF} may be used in signalling to identify the position of RF channels, SSBs, or the like. The global channel raster may be defined for all frequencies from 0 to 100 GHz. The granularity of the global frequency raster may be ΔF_{Global}. F_{REF} may be designated by the NR-ARFCN in the range 0-2016666 on the global channel raster. The relationship between the NR-ARFCN and the F_{REF} in MHz may be given by F_{REF}=F_{REF-Offs}+ΔF_{Global} (N_{REF}−N_{REF-Offs}), where N_{REF} may be the NR-ARFCN and F_{REF-Offs} and N_{REF}-Offs may be defined in table 600.

The channel raster may define a subset of F_{REF}s that may be used to identify the RF channel position in the uplink and downlink. The F_{REF} for an RF channel may map to a resource element on the carrier. For each operating band, a subset of frequencies from the global channel raster may apply to that operating band and form a channel raster with a granularity ΔF_{Raster}, which may be equal to or larger than ΔF_{Global}.

Table 610 relates to channel raster entries for each operating band. Table 610 indicates the applicable NR-ARFCN per operating band. The table provides the RF channel positions on the channel raster in each NR operating band based on the applicable NR-ARFCN and the applicable channel-raster-to-resource-element mapping. The channel numbers that designate carrier frequencies so close to the operating band edges that the carrier extends beyond the operating band edge may not be used.

As shown, for NR operating bands with 100 kHz channel rasters, ΔF_{Raster}=20×ΔF_{Global}. As a result, every twentieth NR-ARFCN within the operating band may apply to the channel raster within the operating band. As further shown, the step size for the channel raster may be <20>. Thus, while the channel raster may be specified with a 5 kHz step size for the full 0-3000 MHz range, the channel raster that applies to the operating band provided in the table may be 100 kHz.

As indicated above, FIG. 6 is provided as an example. Other examples may differ from what is described with respect to FIG. 6.

Operating bands that support the narrow transmission bandwidths may include wide ranges of frequencies on which different operators may operate. Each operating band may include multiple channels having narrow transmission bandwidths that are assigned to respective operators. Operating bands that may support narrow transmission bandwidths may include n26, n28, n85, n100, and/or n106. Operating bands n26, n28, n85, and/or n106 may be used by traditional cellular operators, and operating band n100 may be dedicated for railway usage in Europe and may have no legacy deployment.

Legacy synchronization raster design is too sparse to enable SSB detection in channels having narrow transmission bandwidths (e.g., 3 MHz channels, 5 MHz channels with less than 5 MHz of transmission bandwidth, or the like) for any location within the existing channel raster. Furthermore, the 1200 kHz frequency window employed by the legacy design may cause an SSB (e.g., an SSB having a bandwidth of 20 RBs) to at least partially fall outside of a narrow transmission bandwidth.

FIG. 7 is a diagram illustrating an example 700 associated with a synchronization raster that is based on a transmission bandwidth, in accordance with the present disclosure. As shown in FIG. 7, example 700 includes communication between a network node 110 and a UE 120. In some aspects, network node 110 and UE 120 may be included in a wireless network, such as wireless network 100. Network node 110 and UE 120 may communicate via a wireless access link, which may include an uplink and a downlink.

As shown by reference number 705, the UE 120 may perform, in accordance with a synchronization raster, a cell search in a channel having a transmission bandwidth that is less than or equal to 5 MHz. In some examples, the cell search may involve the UE 120 scanning one or more frequencies for SSBs transmitted by the network node 110. The synchronization raster may be based at least in part on the transmission bandwidth. For example, the synchronization raster may be specific to the transmission bandwidth of the channel. Basing the synchronization raster at least in part on the transmission bandwidth may help to ensure that the UE 120 successfully detects an SSB transmitted within a transmission bandwidth that is less than or equal to 5 MHz and that a connection between the network node 110 and the UE 120 can be successfully established.

As shown by reference number 710, the network node 110 outputs, and the UE 120 receives, the SSB in accordance with the synchronization raster for the channel. For example, transmitting the SSB in accordance with the synchronization raster may enable the network node 110 to transmit the SSB within the transmission bandwidth of the channel. Thus, the UE 120 may successfully detect the SSB transmitted within the transmission bandwidth that is less than or equal to 5 MHz and establish the connection with the network node 110.

As shown by reference number 715, the UE 120 may detect the SSB based at least in part on the cell search. The SSB may contain information (e.g., a PSS, a SSS a PBCH communication, or the like) that enables the UE 120 to establish a connection with the network node 110. As shown by reference number 720, the network node 110 and the UE 120 may establish a connection (e.g., a network connection) with each other based at least in part on the SSB. For example, the UE 120 may use the information contained in the SSB to establish the connection.

As indicated above, FIG. 7 is provided as an example. Other examples may differ from what is described with respect to FIG. 7.

In some examples, the transmission bandwidth may be less than or equal to 3 MHz. Described herein are at least three aspects that may be used in cases where the transmission bandwidth is less than or equal to 3 MHz. In the first aspect, a bandwidth of the SSB may be equal to the transmission bandwidth. For example, the bandwidth of the SSB and the transmission bandwidth may both be 12 RBs. In this case, the SSB may be fully aligned with the transmission bandwidth (e.g., all 12 RBs of the SSB may overlap with the 12 RBs of the transmission bandwidth). Therefore, a step size of the synchronization raster may be equal to a step size of a channel raster of an operating band (e.g., n100), or a frequency range within the operating band, in which the cell search is performed. For example, the synchronization raster and the channel raster may both have a step size of 100 kHz. When the step size of the synchronization raster is equal to the step size of the channel raster, the entirety of the SSB may be transmitted within the transmission bandwidth and, thus, the UE 120 may successfully detect the SSB.

The first aspect may apply to operating bands that may support channels (e.g., operating band n100) that have different transmission bandwidths over time. For example, operating band n100 may be planned for a stepwise transition from legacy technology (e.g., GSM-R) to 12 RB transmission bandwidth within a 3 MHz channel bandwidth, then to 15 RBs (e.g., 15 physical RBs (PRBs)) within the 3 MHz channel bandwidth, then to 20 RB within a 5 MHz channel bandwidth (e.g., having less than 5 MHz transmission bandwidth), and then to 25 RB in the 5 MHz channel bandwidth (e.g., in the full 5 MHz channel bandwidth).

For example, one or more of the bandwidth of the SSB or the transmission bandwidth of the channel may change (e.g., the transmission bandwidth may undergo a stepwise transition and, thus, may not be constant), and the step size of the synchronization raster may be fixed. For example, when the transmission bandwidth or both the transmission bandwidth and the bandwidth of the SSB are increased to 15 PRBs, the synchronization raster step size of 100 kHz may be re-used. The fixed step size (compared to a changing step size) may improve simplicity for, and reduce burden on, the UE 120. The fixed step size may also prevent confusion between synchronization rasters.

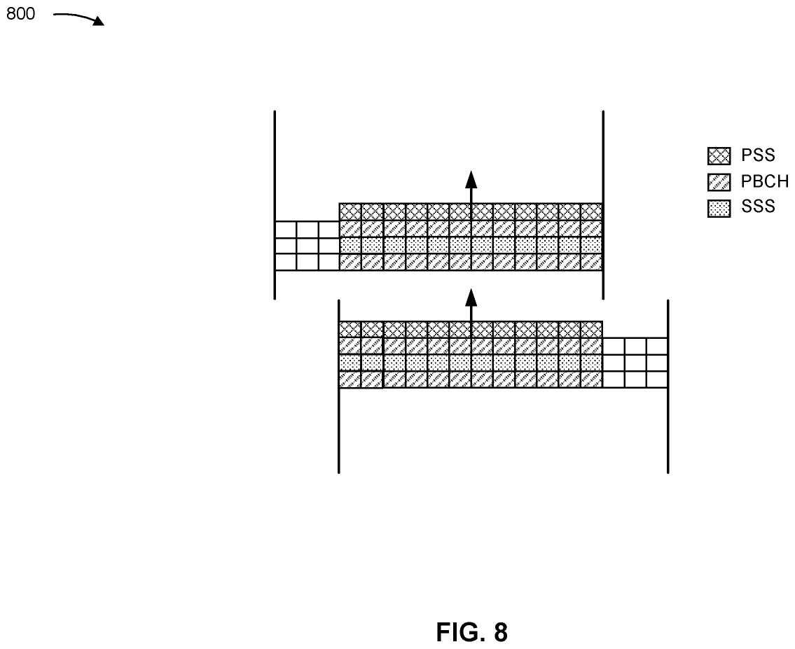

FIG. 8 is a diagram illustrating an example 800 associated with the second aspect, in accordance with the present disclosure. In the second aspect, a bandwidth of the SSB is less than the transmission bandwidth. For example, as shown, the bandwidth of the SSB may be 12 RBs and the transmission bandwidth may be 15 RBs. The SSB may be located in the same frequency positions, and the RF channel that contains the SSB may be located in different frequency positions (e.g., shifted by one or more channel raster step sizes). For example, the RF channel may be shifted in steps of 100 kHz. In some examples, the SSB may be shifted with subcarrier-level granularity within the RF channel (e.g., the SSB boundary within the RF channel may not necessarily strictly align with RF channel RB boundary).

In some examples, a step size of the synchronization raster may be greater than a step size of a channel raster of an operating band (e.g., n26, n28, n85, and/or n106), or a frequency range within the operating band, in which the cell search is performed. For example, the operating band may support a transmission bandwidth in a 3 MHz channel bandwidth and legacy UE communications. The step size of the synchronization raster may or may not be uniform (e.g., for three-point clusters with wide spacing). For example, an individual synchronization raster point may be used for one or more channel raster positions, thereby reducing a quantity of synchronization raster points that are used for the operating band. When the step size of the synchronization raster is greater than the step size of the channel raster, the synchronization raster may be optimized. For example, a sparser synchronization raster may be used to search for a 12 RB SSB within the 15 RB transmission bandwidth for 3 MHz. As a result, the UE 120 may search fewer raster points, which may enable the UE 120 to conserve power. A relatively large gap between a synchronization raster for a channel bandwidth of 3 MHz and a legacy synchronization raster may reduce any impact on legacy UEs.

As indicated above, FIG. 8 is provided as an example. Other examples may differ from what is described with respect to FIG. 8.

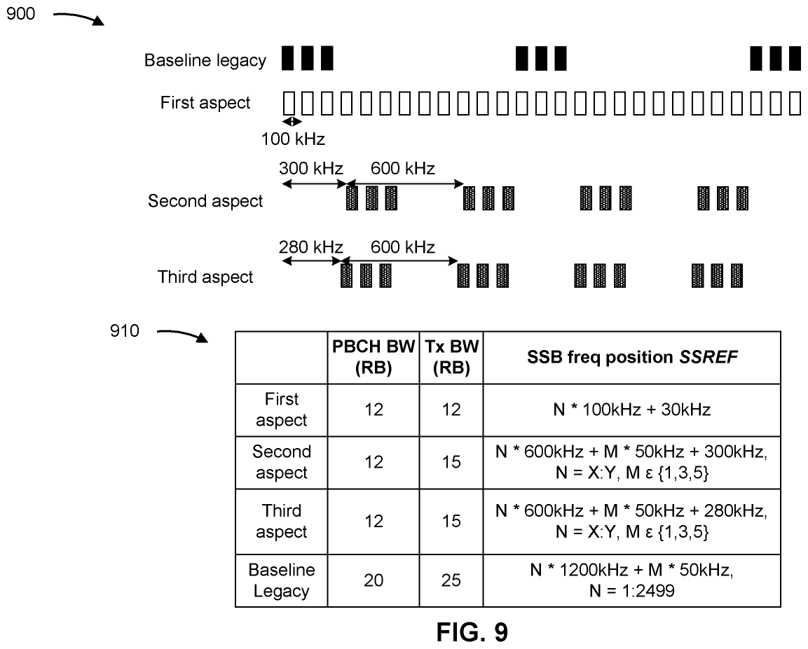

FIG. 9 is a diagram illustrating an example 900 associated with the third aspect and a table 910 containing parameters associated with example 900, in accordance with the present disclosure. Example 900 shows synchronization raster points for the first aspect, the second aspect, the third aspect, and a baseline legacy design. Table 910 contains parameters for the first aspect, the second aspect, the third aspect, and the baseline legacy design as illustrated in example 900.

In the third aspect, the UE 120 may perform the cell search at a first set of synchronization raster points of the synchronization raster, not detect the SSB in the first set of synchronization raster points, perform the cell search at a second set of synchronization raster points of the synchronization raster, and detect the SSB in the second set of synchronization raster points. In some examples, the first set of synchronization points may include the synchronization raster points corresponding to the third aspect as shown in example 900 and in table 910. In some examples, the second set of synchronization raster points may include the synchronization raster points corresponding to the first aspect as shown in example 900 and in table 910.

The first set of synchronization raster points (e.g., corresponding to the third aspect) may be a subset of the second set of synchronization raster points (e.g., corresponding to the first aspect). For example, the synchronization raster points corresponding to the third aspect may be shifted, relative to the synchronization raster points corresponding to the second aspect, to overlap with synchronization raster points corresponding to the first aspect. For example, synchronization raster points of the first aspect may include the synchronization raster points of the third aspect. In this example, the second aspect may not account for (e.g., may not align with) the baseline legacy aspect (e.g., existing 100 kHz raster).

In some examples, the UE 120 may perform the cell search at the first set of synchronization raster points and, when the SSB is not detected, perform the cell search in the synchronization raster points corresponding to the first aspect that UE 120 did not already search. For example, the synchronization raster points of the third aspect may serve as a primary set of synchronization raster points for the UE 120 to search, and the synchronization raster points of the first aspect may serve as a secondary set of synchronization raster points for the UE 120 to search.

When the first set of synchronization raster points is a subset of the second set of synchronization raster points, the co-existence (e.g., alignment) of the third aspect with the first aspect (e.g., the synchronization raster design with 100 kHz step size) may be optimized. For example, the total number of synchronization raster points searched in the third aspect may be less than or equal to (and may not exceed) the total number of synchronization raster points searched in the first aspect. Moreover, the sparser synchronization raster of the third aspect enables power savings for operating bands that undergo a stepwise transition, as described above (e.g., with respect to n100), once the operating band has transitioned to a larger transmission bandwidth (e.g., 15 RB). For example, a larger transmission bandwidth (e.g., 15 RB) may enable the UE 120 to detect the SSB faster than when the transmission bandwidth was narrower.

As indicated above, FIG. 9 is provided as an example. Other examples may differ from what is described with respect to FIG. 9.

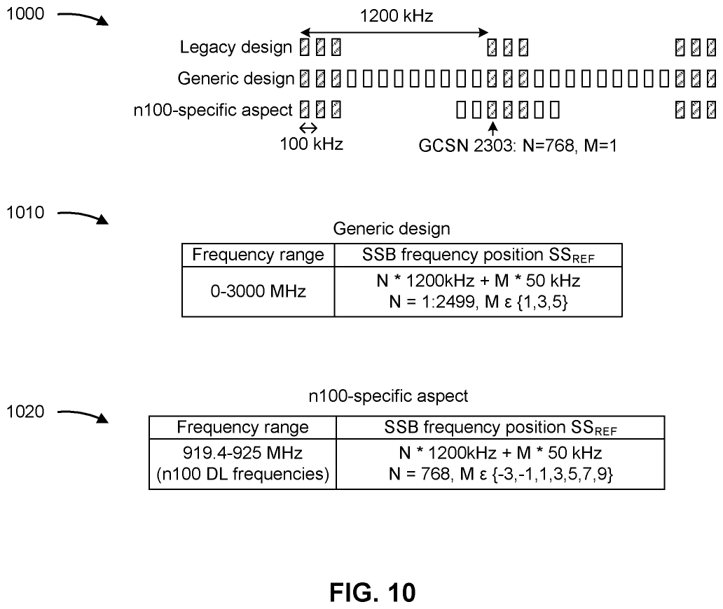

FIG. 10 is a diagram illustrating an example 1000 associated with a transmission bandwidth that may be equal to 5 MHz and tables 1010 and 1020 containing parameters associated with example 1000, in accordance with the present disclosure. Example 1000 shows synchronization raster points for a legacy design (e.g., a previous standards release), a generic design (e.g., a generic raster as shown in table 400), and an n100-specific aspect. Table 1010 contains parameters for the generic design, and table 1020 contains parameters for the n100-specific aspect.

In some examples, a bandwidth of the SSB may be equal to the transmission bandwidth. For example, the bandwidth of the SSB and the transmission bandwidth may both be 20 RBs. In this case, the SSB may be fully aligned with the transmission bandwidth (e.g., all 20 RBs of the SSB may overlap with the 20 RBs of the transmission bandwidth). Therefore, a step size of the synchronization raster may be equal to a step size of a channel raster of an operating band (e.g., n100), or a frequency range within the operating band, in which the cell search is performed. For example, the synchronization raster and the channel raster may both have a step size of 100 kHz. The step size of the synchronization raster being equal to the step size of the channel raster may enable the entirety of the SSB to be transmitted within the transmission bandwidth and, thus, may enable the UE 120 to successfully detect the SSB.

In some examples, the UE 120 may perform the cell search at a set of synchronization raster points of the synchronization raster. The set of synchronization raster points is labeled in example 1000 as “n100-specific aspect”. A subset of the set of synchronization raster points may include synchronization raster points of a global frequency raster or a raster specified for an operating band (e.g., n100). The synchronization raster points of the global frequency raster or the raster specified for the operating band are labeled in example 1000 as “generic design.”

When a subset of the set of synchronization raster points includes synchronization raster points of a global frequency raster or a raster specified for an operating band, specific sections of the general raster may be extended from the legacy design to cover operating band n100 with additional points with 100 kHz spacing. The quantity of n100-specific synchronization raster points may be specified based on the requirements of the spectrum owner. Thus, for example, a transmission bandwidth of 20 PRB may be enabled for channel raster positions in operating band n100, and additional search points may be avoided in certain operating bands. In some examples, the same synchronization raster design may be used after a transition to a transmission bandwidth of 25 RBs.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120) performs operations associated with a synchronization raster based on a transmission bandwidth.

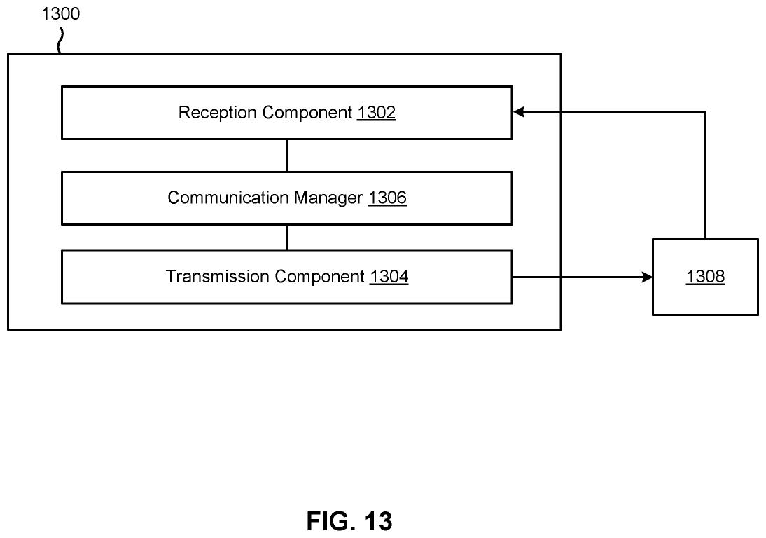

As shown in FIG. 11, in some aspects, process 1100 may include performing, in accordance with a synchronization raster, a cell search in a channel having a transmission bandwidth that is less than or equal to 5 MHz, wherein the synchronization raster is based at least in part on the transmission bandwidth (block 1110). For example, the UE (e.g., using communication manager 1306, depicted in FIG. 13) may perform, in accordance with a synchronization raster, a cell search in a channel having a transmission bandwidth that is less than or equal to 5 MHz, wherein the synchronization raster is based at least in part on the transmission bandwidth, as described above.

As further shown in FIG. 11, in some aspects, process 1100 may include detecting, based at least in part on the cell search, an SSB (block 1120). For example, the UE (e.g., using communication manager 1306, depicted in FIG. 13) may detect, based at least in part on the cell search, an SSB, as described above.

Process 1100 may include additional aspects, such as any single aspect or any combination of aspects described below and/or in connection with one or more other processes described elsewhere herein.

In a first aspect, the transmission bandwidth is less than or equal to 3 MHz.

In a second aspect, alone or in combination with the first aspect, a bandwidth of the SSB is equal to the transmission bandwidth, and a step size of the synchronization raster is equal to a step size of a channel raster of an operating band, or a frequency range within the operating band, in which the cell search is performed.

In a third aspect, alone or in combination with one or more of the first and second aspects, one or more of the bandwidth of the SSB or the transmission bandwidth of the channel change, and the step size of the synchronization raster is fixed.

In a fourth aspect, alone or in combination with one or more of the first through third aspects, a bandwidth of the SSB is less than the transmission bandwidth, and a step size of the synchronization raster is greater than a step size of a channel raster of an operating band, or a frequency range within the operating band, in which the cell search is performed.

In a fifth aspect, alone or in combination with one or more of the first through fourth aspects, performing the cell search includes performing the cell search at a first set of synchronization raster points of the synchronization raster, wherein the UE does not detect the SSB in the first set of synchronization raster points; performing the cell search at a second set of synchronization raster points of the synchronization raster, wherein the first set of synchronization raster points is a subset of the second set of synchronization raster points; and detecting the SSB includes detecting the SSB in the second set of synchronization raster points.

In a sixth aspect, alone or in combination with one or more of the first through fifth aspects, a bandwidth of the SSB is equal to the transmission bandwidth, and a step size of the synchronization raster is equal to a step size of a channel raster of the channel.

In a seventh aspect, alone or in combination with one or more of the first through sixth aspects, performing the cell search includes performing the cell search at a set of synchronization raster points of the synchronization raster, and a subset of the set of synchronization raster points includes synchronization raster points of a global frequency raster or a raster specified for an operating band.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with a synchronization raster based on a transmission bandwidth.

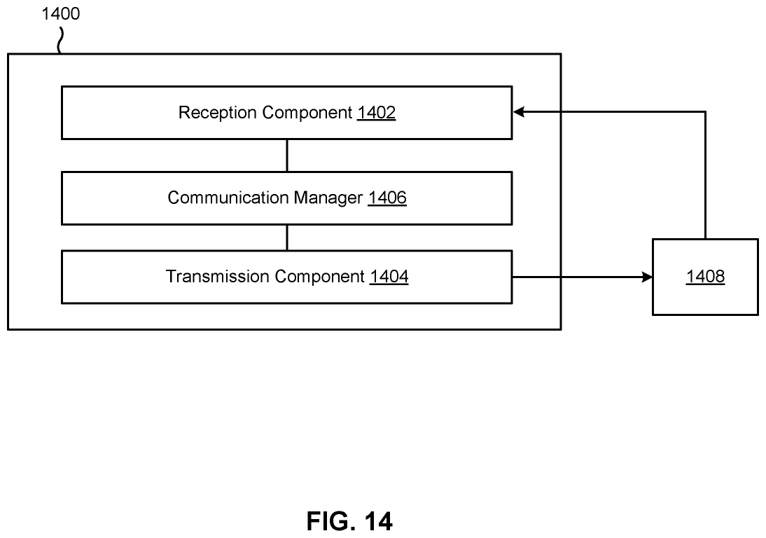

As shown in FIG. 12, in some aspects, process 1200 may include outputting an SSB in accordance with a synchronization raster for a channel having a transmission bandwidth that is less than or equal to 5 MHz, wherein the synchronization raster is based at least in part on the transmission bandwidth (block 1210). For example, the network node (e.g., using transmission component 1404 and/or communication manager 1406, depicted in FIG. 14) may output an SSB in accordance with a synchronization raster for a channel having a transmission bandwidth that is less than or equal to 5 MHz, wherein the synchronization raster is based at least in part on the transmission bandwidth, as described above.

As further shown in FIG. 12, in some aspects, process 1200 may include establishing a connection with a UE based at least in part on the SSB (block 1220). For example, the network node (e.g., using communication manager 1406, depicted in FIG. 14) may establish a connection with a UE based at least in part on the SSB, as described above.

Process 1200 may include additional aspects, such as any single aspect or any combination of aspects described below and/or in connection with one or more other processes described elsewhere herein.

In a first aspect, the transmission bandwidth is less than or equal to 3 MHz.

In a second aspect, alone or in combination with the first aspect, a bandwidth of the SSB is equal to the transmission bandwidth, and a step size of the synchronization raster is equal to a step size of a channel raster of an operating band, or a frequency range within the operating band, in which the cell search is performed.

In a third aspect, alone or in combination with one or more of the first and second aspects, one or more of the bandwidth of the SSB or the transmission bandwidth change, and the step size of the synchronization raster is fixed.

In a fourth aspect, alone or in combination with one or more of the first through third aspects, a bandwidth of the SSB is less than the transmission bandwidth, and a step size of the synchronization raster is greater than a step size of a channel raster of an operating band, or a frequency range within the operating band, in which the cell search is performed.

In a fifth aspect, alone or in combination with one or more of the first through fourth aspects, the UE is configured to: perform a cell search at a first set of synchronization raster points of the synchronization raster, wherein the UE does not detect the SSB in the first set of synchronization raster points; perform the cell search at a second set of synchronization raster points of the synchronization raster, wherein the first set of synchronization raster points is a subset of the second set of synchronization raster points; and detect the SSB in the second set of synchronization raster points.

In a sixth aspect, alone or in combination with one or more of the first through fifth aspects, a bandwidth of the SSB is equal to the transmission bandwidth, and a step size of the synchronization raster is equal to a step size of a channel raster of the channel.

In a seventh aspect, alone or in combination with one or more of the first through sixth aspects, the UE is configured to perform a cell search at a set of synchronization raster points of the synchronization raster, and a subset of the set of synchronization raster points includes synchronization raster points of a global frequency raster or a raster specified for an operating band.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The communication manager 1306 may perform, in accordance with a synchronization raster, a cell search in a channel having a transmission bandwidth that is less than or equal to 5 MHz, wherein the synchronization raster is based at least in part on the transmission bandwidth. The communication manager 1306 may detect, based at least in part on the cell search, an SSB.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may output an SSB in accordance with a synchronization raster for a channel having a transmission bandwidth that is less than or equal to 5 MHz, wherein the synchronization raster is based at least in part on the transmission bandwidth. The communication manager 1406 may establish a connection with a UE based at least in part on the SSB.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: performing, in accordance with a synchronization raster, a cell search in a channel having a transmission bandwidth that is less than or equal to 5 MHz, wherein the synchronization raster is based at least in part on the transmission bandwidth; and detecting, based at least in part on the cell search, an SSB.

Aspect 2: The method of Aspect 1, wherein the transmission bandwidth is less than or equal to 3 MHz.

Aspect 3: The method of Aspect 2, wherein a bandwidth of the SSB is equal to the transmission bandwidth, and wherein a step size of the synchronization raster is equal to a step size of a channel raster of an operating band, or a frequency range within the operating band, in which the cell search is performed.

Aspect 4: The method of Aspect 3, wherein one or more of the bandwidth of the SSB or the transmission bandwidth of the channel change, and wherein the step size of the synchronization raster is fixed.

Aspect 5: The method of Aspect 2, wherein a bandwidth of the SSB is less than the transmission bandwidth, and wherein a step size of the synchronization raster is greater than a step size of a channel raster of an operating band, or a frequency range within the operating band, in which the cell search is performed.

Aspect 6: The method of Aspect 2, wherein performing the cell search includes: performing the cell search at a first set of synchronization raster points of the synchronization raster, wherein the UE does not detect the SSB in the first set of synchronization raster points; and performing the cell search at a second set of synchronization raster points of the synchronization raster, wherein the first set of synchronization raster points is a subset of the second set of synchronization raster points, and wherein detecting the SSB includes: detecting the SSB in the second set of synchronization raster points.

Aspect 7: The method of any of Aspects 1-6, wherein a bandwidth of the SSB is equal to the transmission bandwidth, and wherein a step size of the synchronization raster is equal to a step size of a channel raster of the channel.

Aspect 8: The method of any of Aspects 1-7, wherein performing the cell search includes: performing the cell search at a set of synchronization raster points of the synchronization raster, wherein a subset of the set of synchronization raster points includes synchronization raster points of a global frequency raster or a raster specified for an operating band.

Aspect 9: A method of wireless communication performed by a network node, comprising: outputting an SSB in accordance with a synchronization raster for a channel having a transmission bandwidth that is less than or equal to 5 MHz, wherein the synchronization raster is based at least in part on the transmission bandwidth; and establishing a connection with a UE based at least in part on the SSB.

Aspect 10: The method of Aspect 9, wherein the transmission bandwidth is less than or equal to 3 MHz.

Aspect 11: The method of Aspect 10, wherein a bandwidth of the SSB is equal to the transmission bandwidth, and wherein a step size of the synchronization raster is equal to a step size of a channel raster of an operating band, or a frequency range within the operating band, in which the cell search is performed.

Aspect 12: The method of Aspect 11, wherein one or more of the bandwidth of the SSB or the transmission bandwidth change, and wherein the step size of the synchronization raster is fixed.

Aspect 13: The method of Aspect 10, wherein a bandwidth of the SSB is less than the transmission bandwidth, and wherein a step size of the synchronization raster is greater than a step size of a channel raster of an operating band, or a frequency range within the operating band, in which the cell search is performed.

Aspect 14: The method of Aspect 10, wherein the UE is configured to: perform a cell search at a first set of synchronization raster points of the synchronization raster, wherein the UE does not detect the SSB in the first set of synchronization raster points, perform the cell search at a second set of synchronization raster points of the synchronization raster, wherein the first set of synchronization raster points is a subset of the second set of synchronization raster points, and detect the SSB in the second set of synchronization raster points.

Aspect 15: The method of any of Aspects 9-14, wherein a bandwidth of the SSB is equal to the transmission bandwidth, and wherein a step size of the synchronization raster is equal to a step size of a channel raster of the channel.

Aspect 16: The method of any of Aspects 9-15, wherein the UE is configured to: perform a cell search at a set of synchronization raster points of the synchronization raster, wherein a subset of the set of synchronization raster points includes synchronization raster points of a global frequency raster or a raster specified for an operating band.

Aspect 17: An apparatus for wireless communication at a device, comprising a processor; memory coupled with the processor; and instructions stored in the memory and executable by the processor to cause the apparatus to perform the method of one or more of Aspects 1-16.

Aspect 18: A device for wireless communication, comprising a memory and one or more processors coupled to the memory, the one or more processors configured to perform the method of one or more of Aspects 1-16.

Aspect 19: An apparatus for wireless communication, comprising at least one means for performing the method of one or more of Aspects 1-16.

Aspect 20: A non-transitory computer-readable medium storing code for wireless communication, the code comprising instructions executable by a processor to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
perform, in accordance with a synchronization raster, a cell search in a channel having a transmission bandwidth that is less than or equal to 5 MHz, wherein the synchronization raster is based at least in part on the transmission bandwidth; and
detect, based at least in part on the cell search, a synchronization signal block (SSB).

2. The UE of claim 1, wherein the transmission bandwidth is less than or equal to 3 MHz.

3. The UE of claim 2, wherein a bandwidth of the SSB is equal to the transmission bandwidth, and wherein a step size of the synchronization raster is equal to a step size of a channel raster of an operating band, or a frequency range within the operating band, in which the cell search is performed.

4. The UE of claim 3, wherein one or more of the bandwidth of the SSB or the transmission bandwidth of the channel change, and wherein the step size of the synchronization raster is fixed.

5. The UE of claim 2, wherein a bandwidth of the SSB is less than the transmission bandwidth, and wherein a step size of the synchronization raster is greater than a step size of a channel raster of an operating band, or a frequency range within the operating band, in which the cell search is performed.

6. The UE of claim 2, wherein the one or more processors, to perform the cell search, are configured to:
perform the cell search at a first set of synchronization raster points of the synchronization raster, wherein the UE does not detect the SSB in the first set of synchronization raster points; and
perform the cell search at a second set of synchronization raster points of the synchronization raster, wherein the first set of synchronization raster points is a subset of the second set of synchronization raster points, and the one or more processors, to detect the SSB, are configured to:
detect the SSB in the second set of synchronization raster points.

7. The UE of claim 1, wherein a bandwidth of the SSB is equal to the transmission bandwidth, and wherein a step size of the synchronization raster is equal to a step size of a channel raster of the channel.

8. The UE of claim 1, wherein the one or more processors, to perform the cell search, are configured to:
perform the cell search at a set of synchronization raster points of the synchronization raster, wherein a subset of the set of synchronization raster points includes synchronization raster points of a global frequency raster or a raster specified for an operating band.

9. A network node for wireless communication, comprising:
one or more memories; and
one or more processors, coupled to the one or more memories, configured to:
output a synchronization signal block (SSB) in accordance with a synchronization raster for a channel having a transmission bandwidth that is less than or equal to 5 MHz, wherein the synchronization raster is based at least in part on the transmission bandwidth; and
establish a connection with a user equipment (UE) based at least in part on the SSB.

10. The network node of claim 9, wherein the transmission bandwidth is less than or equal to 3 MHz.

11. The network node of claim 10, wherein a bandwidth of the SSB is equal to the transmission bandwidth, and wherein a step size of the synchronization raster is equal to a step size of a channel raster of an operating band, or a frequency range within the operating band, in which a cell search is performed by the UE.

12. The network node of claim 11, wherein one or more of the bandwidth of the SSB or the transmission bandwidth change, and wherein the step size of the synchronization raster is fixed.

13. The network node of claim 10, wherein a bandwidth of the SSB is less than the transmission bandwidth, and wherein a step size of the synchronization raster is greater than a step size of a channel raster of an operating band, or a frequency range within the operating band, in which a cell search is performed by the UE.

14. The network node of claim 10, wherein the UE is configured to:
perform a cell search at a first set of synchronization raster points of the synchronization raster, wherein the UE does not detect the SSB in the first set of synchronization raster points,
perform the cell search at a second set of synchronization raster points of the synchronization raster, wherein the first set of synchronization raster points is a subset of the second set of synchronization raster points, and
detect the SSB in the second set of synchronization raster points.

15. The network node of claim 9, wherein a bandwidth of the SSB is equal to the transmission bandwidth, and wherein a step size of the synchronization raster is equal to a step size of a channel raster of the channel.

16. The network node of claim 9, wherein the UE is configured to:
perform a cell search at a set of synchronization raster points of the synchronization raster, wherein a subset of the set of synchronization raster points includes synchronization raster points of a global frequency raster or a raster specified for an operating band.

17. A method of wireless communication performed by a user equipment (UE), comprising:
performing, in accordance with a synchronization raster, a cell search in a channel having a transmission bandwidth that is less than or equal to 5 MHz, wherein the synchronization raster is based at least in part on the transmission bandwidth; and
detecting, based at least in part on the cell search, a synchronization signal block (SSB).

18. The method of claim 17, wherein the transmission bandwidth is less than or equal to 3 MHz.

19. The method of claim 18, wherein a bandwidth of the SSB is equal to the transmission bandwidth, and wherein a step size of the synchronization raster is equal to a step size of a channel raster of an operating band, or a frequency range within the operating band, in which the cell search is performed.

20. The method of claim 19, wherein one or more of the bandwidth of the SSB or the transmission bandwidth of the channel change, and wherein the step size of the synchronization raster is fixed.

21. The method of claim 18, wherein a bandwidth of the SSB is less than the transmission bandwidth, and wherein a step size of the synchronization raster is greater than a step size of a channel raster of an operating band, or a frequency range within the operating band, in which the cell search is performed.

22. The method of claim 18, wherein performing the cell search includes:
performing the cell search at a first set of synchronization raster points of the synchronization raster, wherein the UE does not detect the SSB in the first set of synchronization raster points; and
performing the cell search at a second set of synchronization raster points of the synchronization raster, wherein the first set of synchronization raster points is a subset of the second set of synchronization raster points, and wherein detecting the SSB includes:
detecting the SSB in the second set of synchronization raster points.

23. The method of claim 17, wherein a bandwidth of the SSB is equal to the transmission bandwidth, and wherein a step size of the synchronization raster is equal to a step size of a channel raster of the channel.

24. The method of claim 17, wherein performing the cell search includes:
performing the cell search at a set of synchronization raster points of the synchronization raster, wherein a subset of the set of synchronization raster points includes synchronization raster points of a global frequency raster or a raster specified for an operating band.

25. A method of wireless communication performed by a network node, comprising:
outputting a synchronization signal block (SSB) in accordance with a synchronization raster for a channel having a transmission bandwidth that is less than or equal to 5 MHz, wherein the synchronization raster is based at least in part on the transmission bandwidth; and
establishing a connection with a user equipment (UE) based at least in part on the SSB.

26. The method of claim 25, wherein the transmission bandwidth is less than or equal to 3 MHz.

27. The method of claim 26, wherein a bandwidth of the SSB is equal to the transmission bandwidth, and wherein a step size of the synchronization raster is equal to a step size of a channel raster of an operating band, or a frequency range within the operating band, in which a cell search is performed by the UE.

28. The method of claim 27, wherein one or more of the bandwidth of the SSB or the transmission bandwidth change, and wherein the step size of the synchronization raster is fixed.

29. The method of claim 26, wherein a bandwidth of the SSB is less than the transmission bandwidth, and wherein a step size of the synchronization raster is greater than a step size of a channel raster of an operating band, or a frequency range within the operating band, in which a cell search is performed by the UE.

30. The method of claim 25, wherein a bandwidth of the SSB is equal to the transmission bandwidth, and wherein a step size of the synchronization raster is equal to a step size of a channel raster of the channel.
